(19) United States
(12) Patent Application Publication
(10) Pub. No.: US 2004/0232088 A1
(43) Pub. Date: Nov. 25, 2004

(54) Process and plant for the recovery of phosphorus and coagulants from sludge

(76) Inventors: Lars Stenmark, Karlskoga (SE); Stefan Jafverstrom, Norrkoping (SE); Kjell Stendahl, Helsingborg (SE)

Correspondence Address: HARNESS, DICKEY & PIERCE, P.L.C., P.O. BOX 8910, RESTON, VA, 20195, US

(21) Appl. No.: 10/481,017

(22) PCT Filed: Jun. 20, 2002
(86) PCT No.: PCT/SE02/01221

(30) Foreign Application Priority Data
Jun. 21, 2001 (SE) 0102222-7

(51) Int. Cl. C02F 1/72

(52) U.S. Cl. 210/758

(57) ABSTRACT

A process for treatment of waste containing organic material, phosphorous and water in suitable amounts to be a pumpable sludge and in order to be oxidizable through supercritical water oxidation, comprises the steps of: putting the sludge into conditions being supercritical for water; adding oxidant, particularly, oxygen to the sludge, wherein the organic material contained in the waste is substantially completely oxidized by means of supercritical water oxidation; separating the phosphorous from water and from carbon dioxide formed during the oxidation; and recovering the phosphorous by means of dissolving the phosphorous in an alkali.

### TECHNICAL FIELD OF THE INVENTION

The present invention relates to a process and to a plant, respectively, for treatment of waste such as sludge from water purification or wastewater treatment plants.

### DESCRIPTION OF PRIOR ART AND BACKGROUND OF THE INVENTION

As a result of purification of water and cleaning of wastewater, sludge is obtained due to chemical precipitation and flocculation using so called flocculants, which often are aluminum or iron based salts. The sludge comprises further typically organic material; particularly sewage sludge and digested comprise large amounts of organic material. Further, such sludge may contain phosphates and heavy metals.

Recovery of precipitation chemicals and phosphor may be obtained in a plurality of manners, for instance by means of leaching using acid followed by a cleaning process, or instance precipitation, ion exchange or nano-filtration, but often the organic material imposes problems. Normally, the organic material in the waste is burned, wherein, however, an organic residue remains unburned due to incomplete burning. The high temperature that is obtained using combustion causes the residue waste or ash to be sintered together to larger, continuous solid material, which is difficultly soluble.

A plant or recovery of matter in such residue product is described in or instance WO 00/50343. The plant comprises an apparatus, such as a beating or a crushing apparatus, for finally dividing the residue product, a mixing tank for mixing the finally divided residue product with an acid, wherein matter to be recovered is dissolved in the acid, and a filter for filtration of unsolved matter. Further, the plant comprises a plurality of ion exchanges and possibly nano-filters, for separation of the matter dissolved in the acid. It is disclosed that the organic content in the residue product ought to be less than 2% in order not to stop up the ion exchanges.

Drawbacks of such an approach comprise that the residue product has to be treated into a very finally divided form in order to effectively dissolve matter therein, because otherwise the risk is large that some part of the matter is not dissolved and is thus filtered away together with the solid phase. Further only ashes having low organic content may be used in the recovery process.

In EP 0 723 938 A2 is described how organic contaminants are separated from water by means of a precipitation chemical, and the resulting sludge is oxidized, whereafter the residue product is thickened and the precipitation chemical is recovered by means of leaching in sulphuric acid. The oxidation is preferably conducted through ozone oxidation, typically at room temperature and atmospheric pressure, but may be performed with oxidation under 375° C. and 22 MPa or through supercritical oxidation above 375° C. and 22 MPa.

### SUMMARY OF THE INVENTION

In said. EP 0 723 938 A2 is disclosed supercritical oxidation incidentally as one of many alternatives, but nothing further is disclosed about the technique.

The inventors of the present invention have surprisingly discovered that the oxidized residue product created in supercritical water oxidation (SCWO) is made of a fine, very reactive powder and that this enables recovery of precipitation chemicals and phosphates to be made in manners, which were not earlier possible to use.

It is therefore an object of the present invention to provide processes and plants for treatment of waste, which contains water, organic material and a precipitation chemical or phosphorous, where the organic material contained in the waste is oxidized and the precipitation chemical or the phosphorous is recovered, which may use recovery principles that are more effective than earlier known principles.

It is in this context a particular object of the present invention to provide such processes and such plants for treatment of a slurry from a cleaning plant comprising organic material, an iron salt and phosphorous (in the form of phosphate), wherein the organic material contained in the slurry is oxidized and the phosphate is recovered by means of leaching in an alkali and preferably by means of subsequent precipitation as calcium phosphate.

Another object of the present invention is to provide such processes and such plants for treatment of a slurry from a water purification plant comprising organic material, and an aluminum salt, where the organic material contained in the slurry is oxidized and the aluminum salt is recovered by means of leaching in hydrochloric acid, preferably using shortage of acid, for direct formation of polyaluminum chloride.

Yet, a further object of the invention is to provide such processes and such plants, which are effective, uncomplicated, flexible and cost-efficient.

Still a further object of the invention is to provide such processes and such plants, which are unobjectionable in environmental respects.

According to the invention these objects among others are attained by processes and plants in accordance with the appended patent claims.

By means of the present invention considerably improved performance is attained. The inventors of the present invention have realised that by oxidizing the waste using supercritical water oxidation and then recovering phosphates by effective dissolving of the oxidized waste in an alkali, for instance sodium hydroxide, which surprisingly has been shown to be possible as the supercritically oxidized waste is constituted by a fine, very reactive powder, where the phosphorous is well separated from any occurring metals in the waste, a technique is obtained which is considerably better than earlier known approaches. If an iron salt is used as precipitation chemical this is not dissolved in the alkali, but can be separated from the phosphorous and then be recovered through leaching in an acid.

Furthermore, the inventors have realised that by oxidizing the waste using supercritical water oxidation and then recovering the precipitation chemical—if this is an aluminum salt—through effective leaching of the oxidized waste in hydrochloric acid, preferably with shortage of acid and preferably at atmospheric pressure and below the boiling point for water, in order to directly create polyaluminum chloride, which surprisingly has been shown possible as the supercritically oxidized waste is constituted by a fine, very reactive powder, a technique, which is considerably better than earlier known techniques, is obtained.

If the waste contains a heavy metal, such as for instance copper, it may be precipitated in a reduction process by means of adding pure aluminum.

Further, the invention may be applied for destruction of other organic waste, including for instance waste oil and other industrial waste, and foodstuff industry waste. By means of the present invention any phosphorous in the waste may be recovered and any possible heavy metals can be separated.

The supercritical water oxidation is a completely closed process without any risk for production of unwanted bi-products. Toxic chlorine and fluorine based hydrocarbons such as PCB and dioxins are destructed. Only a minimum amount of gaseous products are formed, mainly carbon dioxide, and no flue gas cleaning is required.

Further features of the invention, and advantages of the same, will be apparent from the detailed description of embodiments of the present invention herein below and the appended FIGS. 1-3.

### SHORT DESCRIPTION OF THE FIGURES

FIG. 1 shows a schematic block scheme of a plant for treatment of waste according to an embodiment of the present invention.

FIG. 2 shows a schematic block scheme of a recovery system, which may comprise part of the plant of FIG. 1.

FIG. 3 shows a schematic block scheme of an alternative recovery system, which may comprise part of the plant of FIG. 1.

### DETAILED DESCRIPTION OF EMBODIMENTS

In the following description, for purposes of explanation and not limitation, specific details are set forth, such as particular applications, processes and plants, etc. in order to provide a thorough understanding of the present invention. However, it will be apparent to the man skilled in the art that the present invention may be practised in other embodiments that depart from these specific details.

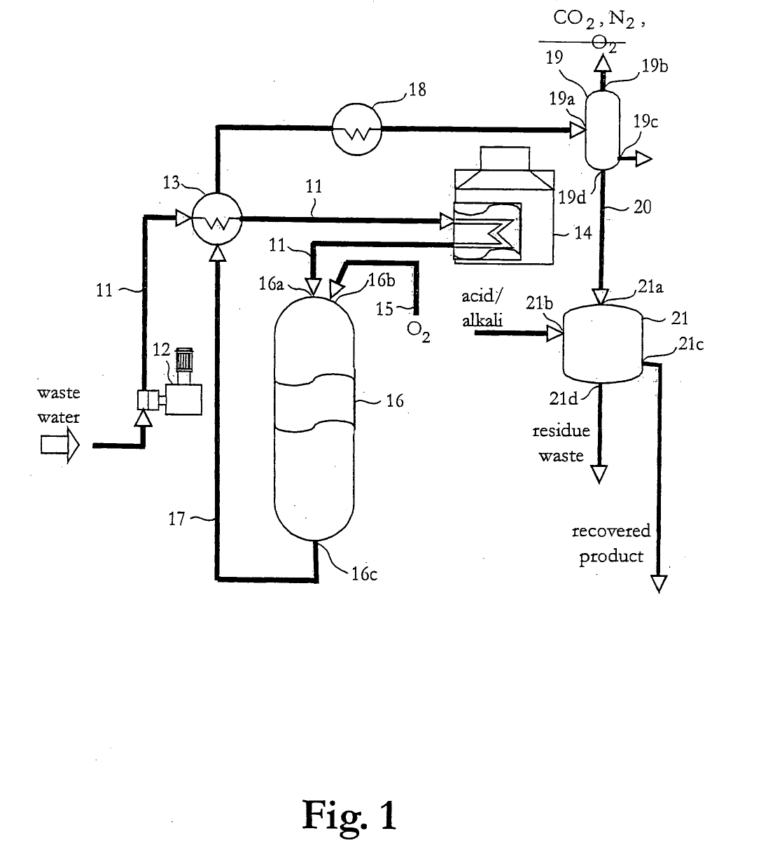

With reference to FIG. 1 a plant for treatment of waste according to an embodiment of the present invention will be described.

The plant comprises one oxidation stage and one recovery stage.

The oxidation stage is mainly a system or supercritical water oxidation (SCWO) and includes a supply conduit 11 for wastewater, a high-pressure pump 12, a heat exchanger 13, a heater 14, and a supply conduit 15 for oxygen, a SCWO-reactor 16, and output conduit 17, a cooler 18 and a separator 19. The SCWO-reactor 16 includes two inlets 16a and 16b for the supply conduits 11 and 15, and an outlet 16c, to which the output conduit 17 is connected. The separator 19 comprises an inlet 19a for the output conduit 17, and three outlets 19b, 19c and 19d for separation of gases, for instance CO₂, O₂ and N₂, cleaned water and residue products.

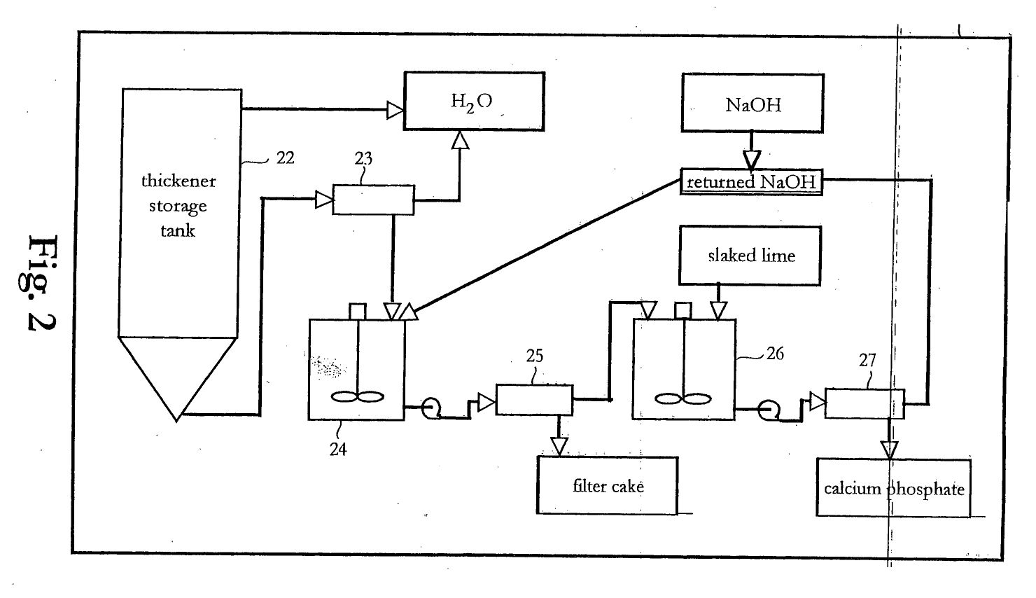

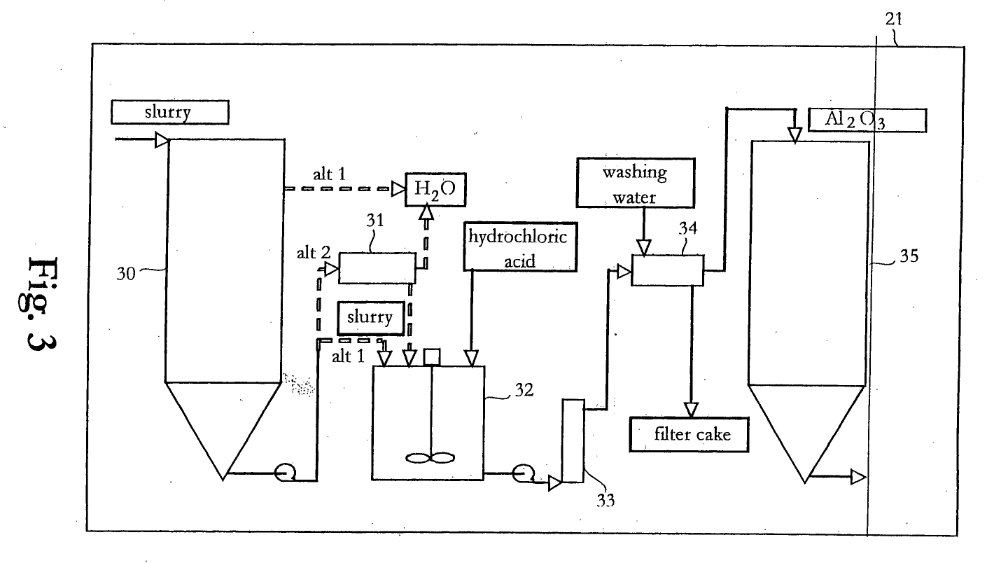

The recovery stage comprises a supply conduit 20 and a recovery tank 21 provided with *two inlets 21a, 21b and two outlets 21c, 21d. The supply conduit 20 is connected between the outlet 19d of the separator and the inlet 21a of the recovery tank. In operation, an alkali or an acid is supplied to the recovery tank via the inlet 21b, wherein the alkali or the acid dissolves the product that is be recovered and this is output from the tank 21 through the outlet 21c, whereas unsolved products or so called residue waster is exhausted from the tank 21 through the outlet 21d. The recovery stage may be provided with further devices for separating different species dissolved in the alkali or the acid. More about this will be closer discussed below with reference to FIGS. 2 and 3.

The plant of FIG. 1 is in its simplest version intended to treat waste containing organic material and a precipitation chemical, for instance an iron or aluminum salt, and a brief. description of the operation of such a plant follows. The waste may typically be sludge from a cleaning or a water plant.

If the waste does not already contain water in suitable amount in order to be a pumpable sludge and in order to be oxidizable via supercritical water oxidation the waste is put into such consistence by means of thickening or diluting. A suitable dry content ought to be 10-15%, and in order to obtain an effective plant the highest possible dry content is utilized.

The sludge is pumped through the supply conduit 11 by means of a high-pressure pump, which increases the pressure to a supercritical pressure for water (22, 13 MPa). The sludge is further pumped through a heat exchanger and is preheated by hot, already reacted sludge, which is pumped from the SCWO-reactor 16 through the output conduit 17. The preheated sludge is further pumped towards the-heater 14, which heats the sludge to a supercritical temperature (374° C.) for water, or close to such a temperature.

The sludge is further pumped into the SCWO-reactor 16 through the inlet 16a. Simultaneously herewith, oxygen or other oxidant is supplied to the SCWO-reactor 16 through the inlet 16b. As a result hereof the organic material contained in the waste is substantially completely oxidized through supercritical water oxidation and the precipitation chemical is converted into an oxide. If the sludge before the reaction has not really reached a supercritical temperature for water the sludge will anyhow react and the released reaction heat will increase the temperature to a supercritical temperature for water and the reaction velocity is increased.

The reacted sludge is transported through the outlet 16c and is guided through the heat exchanger 13 in order to give off heat to the still non-reacted sludge in the supply conduit 11. Then the reacted sludge is cooled in the cooler 18 or in other apparatus in order to take care of the heat, whereafter the sludge is introduced into the separator 19 through one inlet 19a. The separator separates the products mainly by means of the phase, such that gases are guided through the outlet 19b at the top, solid material, a so called residue product, is settled such that the main portion of the liquid phase, i.e. water may be exhausted through the outlet 19c, and finally the solid phase is exhausted through the bottom outlet 19d.

The process in the SCWO-reactor 16 converts rapidly and effectively organic material, which substantially comprises carbon and hydrogen, to carbon dioxide and water at a temperature and pressure above the critical point for water (374° C. and 22, 13 MPa) while releasing energy. The process is completely closed and the destruction efficiency is often higher than 99.9%.

If the non-reacted sludge only contains water, organic waste and the precipitation chemical, clean carbon dioxide is emitted through the outlet 19b, optionally together with oxygen if a surplus of oxygen has been used in the reaction, while the residue product, which is exhausted at 19d, comprises an oxide of the precipitation chemical.

Heavy metals present in the process are converted to their oxides, whereas the phosphorous is oxidized and is exhausted as a residue product at 19d.

Smaller amounts of nitrogen compounds, amines and ammonia, which exist in the waste, are converted to molecular nitrogen and not to NOx, which is an acidifying and fertilizing residue product, which is therefore not wanted in the gaseous phase. The nitrogen is outlet at 19b together with the other gases.

The residue products exhausted through the outlet 19d exist, due to the nature of the SCWO-reaction, in a finally, reactive form and is well suited for treatment to recover, inter alia, the precipitation chemical.

Thus, the residue products are transported through supply line 20 into the recovery tank 21 and alkali (if the residue products comprise phosphorous) or hydrochloric acid, particularly using shortage of acid (if the oxidized residue products comprise aluminum) is added through inlet 21b, wherein the phosphorous is dissolved or the aluminum is dissolved to directly form polyaluminum chloride. Insoluble material is settled and is exhausted through the outlet 21d as a residue waste, while the recovered phosphorous or polyaluminum chloride is exhausted through outlet 21c, possibly after filtration.

With reference next to FIG. 2, which illustrates a recovery system 21 usable in the plant of FIG. 1, a first particular embodiment of the invention will be described.

The residue product from the SCWO-reactor is in this embodiment a slurry with a fine, very reactive powder comprising iron oxide, phosphorous oxide (P₂O₅), possibly oxides of heavy metals, and silicates and other insoluble residue products, which may originate for instance from sewage sludge from a cleaning plant. This residue product is collected in a thickener/storage tank 22 and Is then filtered through a filter 23 in order to increase the dry content. The thickened and filtered residue product is collected in a reactor 24, to which caustic solution (NaOH) is added. It has surprisingly been seen that the phosphorous very effectively is dissolved in the caustic solution and forms sodium phosphate, which is believed to depend on the very finely divided and reactive nature of the residue product from the supercritical water oxidation, where the phosphorous and the iron are separated. The remaining matter iron oxide, possibly oxides of heavy metals, and silicates and other insoluble residue products remain in solid phase and can easily be filtered away in a filter 25. As an alternative to caustic solution, ammonia may be used for formation of ammonium phosphate in solution.

The solution is then transported to a second reactor 26, to which lime (CaO or Ca(OH)₂) is added. Hereby calcium phosphate is precipitated, which can thus be separated from the solution in a third filter 27. The caustic solution is then returned to the reactor 24. A smaller amount of caustic solution has to be added due to losses in the system.

Calcium phosphate with a dry content of about 70% is obtained at the third filter 27, which is an excellent raw material for commercial fertilizers.

Obviously, the filter cake from the second filter 25, which contains iron oxide, possibly oxides of heavy metals, and silicates and other insoluble residue products may be further treated in order to recover the iron salt and separate the heavy metals. This may be performed for instance by leaching in an acid and reduction followed by a respective filtering step or by means of other processes known within the technical field.

With reference now to FIG. 3, which illustrates a recovery system 21, which may be used in the plant of FIG. 1, a second particular embodiment of the invention will be described.

The residue product from the SCWO-reactor is in this embodiment a slurry with a fine, very reactive powder comprising an aluminum salt, possibly oxides of heavy metals, and silicate and other insoluble residue products, which may originate for instance from a water cleaning plant. This residue product is collected in a thickener/storage tank 30 and is then filtered through a filter 31 or other kind of dewatering device in order to increase the dry content. The thickened and filtered residue product is collected in a reactor 32 to which hydrochloric acid is added—preferably in stoichiometric shortage, particularly in 50% shortage. The reactor 32 operates preferably at atmospheric pressure and at a temperature below the boiling point of water. It has surprisingly been seen that the aluminum very effectively and directly forms polyaluminum chloride, which is believed to depend on the finely divided and very reactive nature of the residue product from the supercritical water oxidation. Thus, it is directly obtained

Al(OH)_{1.5}Cl_{1.5}

with 50% basicity without having to utilize pressure boiling or to produce the aluminum chloride by means of the stoichiometric reaction

Al(O)₃+3HCl→AlCl₃+3H₂O

and thereafter to produce highly basic polyaluminum chloride by means of adding an alkali, which may be performed according to conventional processes. By means of the process for forming polyaluminum chloride according to the invention less amounts of hydrochloric acids are wasted and no alkali is needed.

Oxides of heavy metals will also be dissolved, but the heavy metals will be directly precipitated in a heavy metal reduction stage, in which pure aluminum is added in order to obtain the reduction

2Al+3Cu²⁺→2Al³⁺+3Cu(s)

here exemplified with copper. The heavy metals may then be filtered away in a filter 34 and may be taken care of/deposited in a suitable manner. The solution is then transported to a storage tank for storage of polyaluminum chloride, which may be reused as a flocculant/precipitation chemical.

The particular embodiments of the invention illustrated in FIGS. 2 and 3 may certainly be combined in case the residue product contains both phosphorous and aluminum.

It shall be realised by the man skilled in the art that the invention is applicable for waste other than those containing precipitation chemicals, for instance industrial and food stuff industry waste comprising organic material and phosphorous or heavy metals. The phosphorous may be recovered and the heavy metals can be separated in the above-described manner.

It is obvious that the invention can be varied in a plurality of manners. All such variations, which are obvious for a man skilled in the art, are intended to fall within the scope of the appended patent claims.

1-26. (Canceled)

27. A process for treatment of waste containing organic material, phosphorous and water in suitable amounts in order to be a pumpable sludge and in order to be oxidizable through supercritical water oxidation, said process comprising the steps of:
putting said sludge into conditions being supercritical to water;
adding oxidant to said sludge, whereupon the organic material contained in said waste is substantially completely oxidized through supercritical water oxidation;
separating said phosphorous from water and from carbon dioxide formed during the oxidation; and
recovering said phosphorous by means of dissolving said phosphorous in an alkali.

28. The process of claim 27 wherein said alkali is caustic solution and said phosphorous dissolved in said alkali is obtained in the form of sodium phosphate.

29. The process of claim 27 wherein said dissolved phosphorous is precipitated by means of adding lime and forming calcium phosphate.

30. The process of claim 29 wherein said calcium phosphate is separated from said alkali.

31. The process of claim 30 wherein said alkali separated from said calcium phosphate is returned and used in the step of recovering said phosphorous by means of dissolving said phosphorous in an alkali.

32. The process of claim 26 wherein the waste contains a precipitation chemical, and wherein
said precipitation chemical is converted to an oxide by means of said supercritical water oxidation;
said precipitation chemical converted into an oxide is separated together with said phosphorous; and
said precipitation chemical converted to an oxide remains substantially not dissolved when said phosphorous is dissolved in said alkali.

33. The process of claim 32 wherein said precipitation chemical is separated from said phosphorous dissolved in said alkali.

34. The process of claim 33 wherein said precipitation chemical is recovered by means of dissolving its oxide in an acid.

35. The process of claim 34 wherein said waste contains a heavy metal, and wherein
said heavy metal is converted to an oxide by means of said supercritical water oxidation;
said heavy metal converted to an oxide is separated together with said phosphorous;
said heavy metal converted to an oxide remains substantially not dissolved when said phosphorous is dissolved in said alkali;
said heavy metal converted to an oxide is dissolved together with said precipitation chemical converted to an oxide in said acid; and
said heavy metal is separated from said precipitation chemical in a reduction step where said heavy metal is precipitated.

36. The process of claim 34 wherein said waste contains silicate, which remains substantially intact through the supercritical water oxidation; is separated together with said precipitation chemical converted to an oxide and dissolved in said acid; and is separated from said precipitation chemical by means of its insolubility in said acid.

37. The process of claim 26 wherein said waste is sewage sludge from a cleaning plant.

38. The process of claim 26 wherein said precipitation chemical is an iron or aluminum salt.

39. A plant for treatment of waste containing organic material and phosphorous comprising:
a reactor provided for supercritical water oxidation of the waste, wherein the organic material contained in said waste is substantially completely oxidized and wherein said reactor comprises inlets for reactants comprised in the waste, water and oxidant, and an outlet for products comprising water, carbon dioxide and said phosphorous;
a heater and a high-pressure pump provided for putting reactants into supercritical conditions for water in or before the reactor;
a separator connected to the outlet of said reactor for separation of said phosphorous from water and carbon dioxide; and
a device provided for recovery of said phosphorous by means of dissolving said phosphorous in an alkali, wherein said device for recovery comprises a reactor connected to said separator for receiving said phosphorous separated therein, and comprises an inlet for receiving said alkali.

40. The plant of claim 39 wherein said device for recovery comprises a second reactor connected to said first reactor for receiving said phosphorous dissolved therein, and comprises an inlet for receiving lime for precipitation of said dissolved phosphorous as calcium phosphate.

41. The plant of claim 40 wherein said device for recovery comprises a first separation device for separating said precipitated calcium phosphate from said alkali.

42. The plant of claim 41 wherein said device for recovery comprises a return conduit for guiding said alkali separated from said calcium phosphate back to said first reactor.

43. The plant of claim 42 wherein the waste contains a precipitation chemical, and wherein
said reactor is adapted such that precipitation chemical by means of the supercritical water oxidation is converted to an oxide;
said separator is adapted such that said precipitation chemical is separated together with said phosphorous; and
said precipitation chemical converted to an oxide is substantially insoluble in said alkali.

44. The plant of claim 43 wherein said device for recovery comprises a second separation device for separating said precipitation chemical from said phosphorous dissolved in said alkali.

45. The plant of claim 44 wherein said device for recovery comprises a third reactor connected to said second separation device for receiving said precipitation chemical separated therein, and comprises an inlet for receiving an acid for recovery of said precipitation chemical by means of dissolving its oxide in said acid.

46. The plant of claim 39 wherein said precipitation chemical is an iron or an aluminum salt.

47. A process for treatment of waste containing organic material, a precipitation chemical in the form of an aluminum salt, and water in suitable amounts in order to be a pumpable sludge and in order to be oxidized by supercritical water oxidation, said process comprising the steps of:
putting said sludge into conditions being supercritical for water;
adding an oxidant to said sludge, wherein the organic material contained in said waste is substantially completely oxidized through the supercritical water oxidation and said aluminum salt is converted to an oxide;
said aluminum salt converted to an oxide is separated from water and from carbon dioxide formed during the oxidation; and
said aluminum salt is recovered by means of dissolving its oxide in hydrochloric acid,
wherein the recovery is performed with stoichiometric shortage of acid for direct formation of polyaluminum chloride.

48. The process of claim 47 wherein said recovery is performed by means of dissolving its oxide in hydrochloric acid at atmospheric pressure and at a temperature below the boiling point of water.

49. The process of claim 47 wherein the waste contains a heavy metal, and wherein
said heavy metal is converted to an oxide through the supercritical water oxidation;
said heavy metal converted to an oxide is separated together with said aluminum salt converted to an oxide;
said heavy metal converted to an oxide is dissolved together with said aluminum salt converted to an oxide in said hydrochloric acid; and
heavy metal is separated from said aluminum salt.

50. The process of claim 49 wherein said heavy metal is separated from said aluminum salt through heavy metal reduction whereupon said heavy metal is precipitated.

51. A plant for treatment of waste containing organic material and a precipitation chemical in the form of an aluminum salt comprising:
a reactor provided for supercritical water oxidation of the waste, wherein the organic material contained in said waste is substantially completely oxidized and said aluminum salt is converted to an oxide wherein the reactor comprises inlets for reactants comprised in the waste, water and oxidant, and an outlet for products comprising water, carbon dioxide and said aluminum salt converted to an oxide;
a heater and a high-pressure pump provided for putting reactants into conditions being supercritical for water before or in the reactor;
a separator connected to the outlet of said reactor for separating said aluminum salt converted to an oxide from water and carbon dioxide; and
a device provided for recovery of said aluminum salt through dissolving of said aluminum salt converted to an oxide in hydrochloric acid, wherein said device for recovery is connected to said separator to receive the aluminum salt separated therein and converted to an oxide, and comprises an inlet for receiving said hydrochloric acid so that said recovery is performed with stoichiometric shortage of acid for direct formation of polyaluminum chloride.

52. The plant of claim 51 wherein said device for recovery is adapted to dissolve said aluminum salt converted to an oxide in hydrochloric acid at atmospheric pressure and at a temperature below the boiling point for water.

53. The process of claim 26 wherein said oxidant is oxygen.

54. The process of claim 30 wherein said calcium phosphate is separated from said alkali by means of a filter.

55. The plant of claim 31 wherein said first separation device is a first filter.

56. The plant of claim 34 wherein said second separation device is a second filter.

57. The process of claim 47 wherein said oxidant is oxygen.
